(19) United States
(12) Patent Application Publication
(10) Pub. No.: US 2024/0106791 A1
(43) Pub. Date: Mar. 28, 2024

(54) INFORMATION PROCESSING APPARATUS

(71) Applicant: TOYOTA JIDOSHA KABUSHIKI KAISHA, Toyota-shi Aichi-ken (JP)

(72) Inventor: Kazuya OKADA, Kita-ku Tokyo-to (JP)

(73) Assignee: TOYOTA JIDOSHA KABUSHIKI KAISHA, Toyota-shi Aichi-ken (JP)

(21) Appl. No.: 18/372,286

(22) Filed: Sep. 25, 2023

(30) Foreign Application Priority Data
Sep. 27, 2022 (JP) 2022-153240

(51) Int. Cl. H04L 61/2539; H04L 61/4511; H04L 61/5007

(52) U.S. Cl. CPC H04L 61/2539; H04L 61/4511; H04L 61/5007

(57) ABSTRACT

An information processing apparatus comprises a controller configured to execute: obtaining, from a user device, a query requesting name resolution of a first device accessible via a wide area network by DNS protocol; obtaining a first IP address, which is an IP address of the first device, based on the query; generating a second IP address that is a dummy IP address corresponding to the first IP address; replacing the first IP address with the second IP address, and transmitting a response to the query to the user device, with the second IP address as result of the name resolution; when a connection request addressed to the second IP address is received from the user device, transmitting the connection request to the wide area network, after replacing a destination from the second IP address to the first IP address.

### CROSS REFERENCE TO THE RELATED APPLICATION

This application claims the benefit of Japanese Patent Application No. 2022-153240, filed on Sep. 27, 2022, which is hereby incorporated by reference herein in its entirety.

### BACKGROUND

### Technical Field

This disclosure relates to mobile communications.

### Description of the Related Art

The method of connecting private networks by the Internet to communicate with each other is well known.

In this regard, for example, Japanese Patent Laid-Open No. 2003-087336 discloses a system that performs IP address translation for connections between VPN segments.

### SUMMARY

The purpose of this disclosure is to conceal an IP address of a server apparatus to which a client device connects.

The present disclosure in one aspect provides an information processing apparatus comprising a controller configured to execute: obtaining, from a user device, a query requesting name resolution of a first device accessible via a wide area network by DNS protocol; obtaining a first IP address, which is an IP address of the first device, based on the query; generating a second IP address that is a dummy IP address corresponding to the first IP address; replacing the first IP address with the second IP address, and transmitting a response to the query to the user device, with the second IP address as result of the name resolution; when a connection request addressed to the second IP address is received from the user device, transmitting the connection request to the wide area network, after replacing a destination from the second IP address to the first IP address.

Other aspects include a method to be executed by the above devices, a program for causing a computer to execute the method, or a computer-readable storage medium non-transiently storing the program.

According to this disclosure, the server apparatus address of the server apparatus to which the client device connects can be kept secret.

### BRIEF DESCRIPTION OF THE DRAWINGS

FIG. 1 indicates an overview of the first embodiment of the communication system.

FIG. 2 indicates the components of the in-vehicle device.

FIG. 3 indicates the components of the resolver DNS.

FIG. 4 indicates an example of a translation table generated by the resolver DNS.

FIG. 5 indicates the components of the translation device.

FIG. 6 indicates a sequence diagram of the data exchanged between the components.

FIG. 7 indicates a flowchart of the process performed by the translation device.

### DESCRIPTION OF THE EMBODIMENTS

In recent years, vehicles have become increasingly connected, and wireless network connectivity is available in an increasing number of vehicles. Communication between the vehicle and the server apparatus makes it possible to provide the vehicle with information that contributes to traffic safety and the latest traffic information.

In such systems, attacks through the network can be a problem. For example, if the IP addresses (in this specification, IPv4 and IPv6 addresses are meant) of the server apparatus communicating with the vehicle are known to an attacker, there is a risk of a fake vehicle imitation or denial-of-service attack.

However, it is difficult to conceal the IP address of a device that is the destination of communication because packet communication by the Internet Protocol (IP) usually includes a source IP address and a destination IP address in the IP header section. In particular, since terminals installed in automobiles often use mobile communication networks, there is a risk that packets may be read by terminals in the same network and the device to which they are communicating may be identified.

The information processing apparatus of the present disclosure solves such problems.

The information processing apparatus according to the first aspect of the present disclosure comprises a controller configured to execute: obtaining, from a user device, a query requesting name resolution of a first device accessible via a wide area network by DNS protocol; obtaining a first IP address, which is an IP address of the first device, based on the query; generating a second IP address that is a dummy IP address corresponding to the first IP address; replacing the first IP address with the second IP address, and transmitting a response to the query to the user device, with the second IP address as result of the name resolution; when a connection request addressed to the second IP address is received from the user device, transmitting the connection request to the wide area network, after replacing a destination from the second IP address to the first IP address.

The information processing apparatus pertaining to this disclosure functions as a device that performs name resolution on a network (resolver) and IP address translation. The information processing apparatus may be located on the same network as the user device, or it may be located in a portion that aggregates multiple networks. The information processing apparatus performs name resolution in response to requests from the user device and also performs IP address translation of packets sent from the user device to and from the wide area network.

The controller that the information processing apparatus has obtains a query (typically a DNS query) from the user device to resolve the name of the first device and, based on the query, obtains the IP address (first IP address) of the first device. The first IP address can be obtained by recursively querying other DNS servers, etc. that perform name resolution. In other words, the controller provides the function as a name resolver.

The controller also generates a second IP address, which is a dummy IP address corresponding to the first IP address. The second IP address is an IP address used for the purpose of keeping the first IP address confidential. The second IP address may be a non-existent IP address.

The controller sends the second IP address instead of the first IP address to the user device as a response to the query. This will cause a user device trying to communicate with the first device to generate a connection request destined to the second IP address.

On the other hand, when such a connection request is sent from a user device, the controller replaces the destination from the second IP address to the first IP address and forwards it to the wide area network.

According to such a configuration, the IP address of the first device is treated as a second IP address instead of the first IP address in the network to which the user device is connected. In other words, even if packets sent and received between the user device and the first device are intercepted in the network, the true IP address of the first device will not be known. This will reduce the risk of attacks, etc.

When the controller receives a response message to a connection request from the first device, it may replace the transmission source in the response message from the first IP address to the second IP address and forward the response message to the user device.

This allows the first IP address in the return packet to be kept secret.

The controller may also replace the first IP address with the second IP address using different rules for each of the multiple user devices.

If the controller generates a second IP address using the same rules, the combination of the first and second IP addresses is fixed. To avoid this, a second IP address may be generated using different rules for each user device. According to such a configuration, different user devices will have different second IP addresses, which will have the effect of disturbing attackers.

Replacing the first IP address with the second IP address includes replacing the first IP address with the second IP address during name resolution.

The controller may also register the first IP address, the second IP address, and the identification information of the user device in the translation table in association with each other. By using such a translation table, IP address translation can be easily performed.

When the controller receives a connection request from a user device, it may check the identification information (e.g., source IP address) and destination IP address included in the connection request against the translation table, and if a matching record exists, it may acquire the first IP address included in the record and replace the destination may be replaced by the first IP address.

The controller may also reject connection requests destined for a second IP address registered in the translation table that are sent from a device with identification information different from that associated with the registered second IP address.

If a connection request is sent to the first device from a device not registered in the translation table (i.e., if a replay attack is made copying the second IP address), the connection can be rejected.

Specific embodiments of the disclosure are described below based on the drawings. The hardware configuration, module configuration, functional configuration, etc. described in each embodiment are not intended to limit the technical scope of the disclosure to them alone, unless otherwise stated.

### First Embodiment

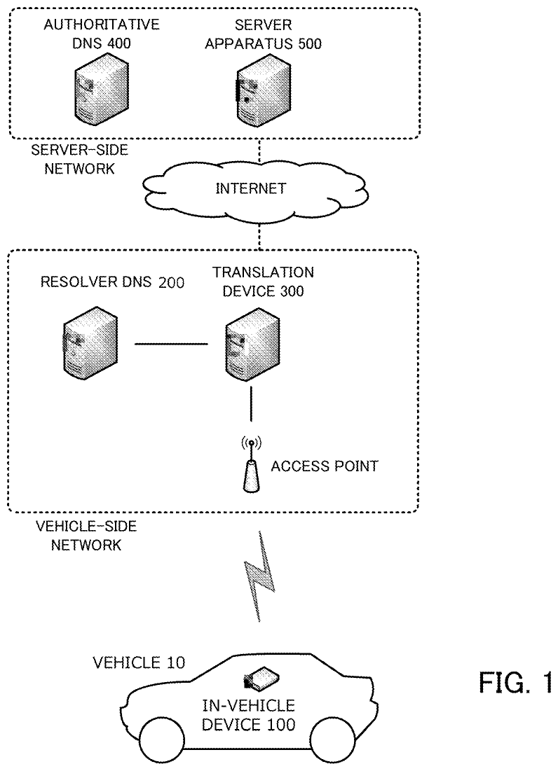

An overview of the first embodiment of the communication system is described with reference to FIG. 1. This communication system is a system in which a vehicle 10 equipped with an in-vehicle device 100 communicates with a server apparatus 500 via a wide-area network (Internet). There may be more than one vehicle 10 (in-vehicle device 100) included in the system.

Vehicle 10 is a connected car with wireless communication capabilities. The vehicle 10 can connect to a given network and communicate with any device via the Internet.

The server apparatus 500 is a device that collects data from the in-vehicle device 100 and provides information to the in-vehicle device 100.

The network to which the vehicle 10 is connected and the network in which the server apparatus 500 is located are connected to each other via the Internet.
Hereafter, the network to which the vehicle 10 connects will be referred to as the vehicle-side network and the network in which the server apparatus 500 is located will be referred to as the server-side network.

The vehicle-side network contains access points for wireless communication with the in-vehicle device 100, a resolver DNS 200 for name resolution on the network, and a translation device 300 for IP address translation between the Internet and the vehicle-side network. An access point is a device that provides wireless access to the vehicle-side network.

In addition to the server apparatus 500, an authoritative DNS server 400, is located in the server-side network to perform name resolution for the server apparatus 500. The authoritative DNS 400 may be located on the server-side network or on a separate network.

The vehicle-side network and the server-side network are interconnected by a wide-area network (Internet). The vehicle-side network may be a wireless communication network using Wi-Fi (registered trademark), etc., or a mobile communication network using cellular communication methods.

Each component of the system will be described in detail.

Vehicle 10 is a connected car with the ability to communicate with external networks. The vehicle 10 is equipped with an in-vehicle device 100.

The in-vehicle device 100 is a computer for collecting and providing information. In this embodiment, the in-vehicle device 100 has the function of collecting and transmitting information about the driving of the vehicle 10 to the server apparatus 500 and providing information to the occupants of the vehicle 10 based on the information received from the server apparatus 500.

The in-vehicle device 100 may be a device that provides information to the occupants of the vehicle 10 (e.g., a car navigation device), or it may be an electronic control unit (ECU) that the vehicle 10 has. The in-vehicle device 100 may also be a data communication module (DCM) with communication capabilities.

The in-vehicle device 100 can be configured as a computer with a processor such as a CPU or GPU, main memory such as RAM or ROM, and auxiliary storage such as EPROM, hard disk drive, or removable media. An operating system (OS), various programs, various tables, etc. are stored in the auxiliary memory device, and by executing the programs stored there, each function that meets a given purpose can be realized, as described below. However, some or all of the functions may be realized by hardware circuits such as ASICs or FPGAs.

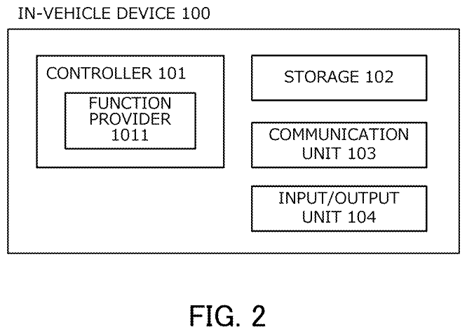

FIG. 2 shows the system configuration of the in-vehicle device 100.

The in-vehicle device 100 comprises a controller 101, a storage 102, a communication unit 103, and an input/output unit 104.

The controller 101 is an arithmetic unit that implements various functions of the in-vehicle device 100 by executing a predetermined program. The controller 101 may be realized by, for example, a CPU.

The controller 101 includes a function provider 1011 as a functional module. The functional module may be realized by executing the stored program by the CPU.

The function-providing unit 1011 executes various functions provided by the in-vehicle device 100. Functions provided by the in-vehicle device 100 include, for example, the following
Navigation functions
   This function provides route navigation based on map data provided by the server apparatus 500.
Traffic information provision function
   This function provides traffic information based on information provided by the server apparatus 500.
Data transmission function
   This function collects information (speed information, location information, etc.) about the driving of the vehicle 10 and transmits it to the server apparatus 500.

These functions can be provided, for example, via the input/output unit 104 (touch panel). To provide these functions, the in-vehicle device 100 may also have a GPS antenna, GPS module, etc.

The function provider 1011 is configured to perform these functions by communicating with the server apparatus 500. The function provider 1011 stores the URL of the server apparatus 500, which is the communication destination, and queries (DNS query) the resolver DNS 200 using that URL. The resulting IP address is used to communicate with the server apparatus 500. Communication is initiated when the in-vehicle device 100 sends a connection request to the server apparatus 500 and the server apparatus 500 sends a response message in response.

The storage 102 is a memory device that includes a main memory and an auxiliary memory. An operating system (OS), various programs, various tables, etc. are stored in the auxiliary memory, and each function that meets a given purpose, as described below, can be realized by loading the programs stored there into the main memory and executing them.

The main memory may include RAM (Random Access Memory) and ROM (Read Only Memory). Auxiliary storage devices may also include EPROM (Erasable Programmable ROM) and hard disk drives (HDD, Hard Disk Drive). In addition, auxiliary storage devices may include removable media, i.e., portable recording media.

The communication unit 103 is a wireless communication interface for connecting the in-vehicle device 100 to a network. The communication unit 103 is configured to communicate with a network (vehicle-side network) by a communication standard such as mobile communication, wireless LAN, Bluetooth (registered trademark), etc., for example.

The input/output unit 104 is a unit configured to accept input operations performed by the user of the device and presenting information. This system includes a single touch panel display. That is, it includes an LCD display and its control unit, and a touch panel and its control unit.

Next, the resolver DNS 200 is described. Resolver DNS 200 is a device that performs name resolution for server apparatus 500 in response to DNS queries received from server apparatus 100.

Resolver DNS 200 can be configured as a computer with a processor such as a CPU or GPU, main memory such as RAM and ROM, and auxiliary storage such as EPROM, hard disk drive, and removable media. The resolver DNS 200 may include a single computer or multiple computers that are linked to each other.

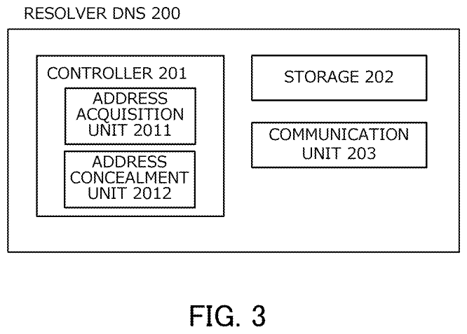

FIG. 3 shows the system configuration of the resolver DNS 200. Resolver DNS 200 comprises a controller 201, a storage 202, and a communication unit 203.

The controller 201 is an arithmetic unit that governs the control performed by the resolver DNS 200. The controller 201 can be realized by an arithmetic processor such as a CPU.

The controller 201 includes two functional modules: the address acquisition unit 2011 and the address concealment unit 2012. Each functional module may be realized by executing a program stored in the auxiliary storage by the CPU.

The address acquisition unit 2011 recursively queries a high-level DNS server based on the DNS query received from the in-vehicle device 100 to obtain the IP address of the server apparatus 500. The IP address of the server apparatus 500 is provided by the authoritative DNS 400, but the address acquisition unit 2011 may communicate with multiple DNS servers in the process.

The address concealment unit 2012 rewrites the IP address of the server apparatus 500 (“first IP address”) provided by the authoritative DNS 400 to a dummy IP address (“second IP address”).

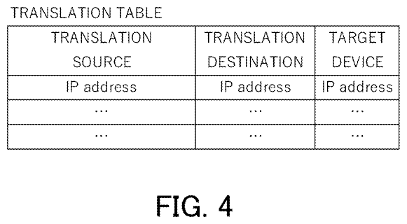

Rewriting of IP addresses can be based on arbitrary translation rules. Resolver DNS 200 may, for example, store a translation table as shown in FIG. 4 and perform IP address rewriting based on the translation table.

In the example in FIG. 4, the translation source field is the field where the first IP address is stored. The translation destination field is the field where the second IP address is stored. The target device field is a field in which the IP address of the in-vehicle device 100 is stored. In the example in FIG. 4, the first IP address is replaced by the second IP address using different translation rules for each of the 100 in-vehicle devices.

The second IP address may be selected from a pre-generated list (e.g., by order, random, etc.) or may be generated dynamically by any method, such as function arithmetic, random generation, etc.

The address concealment unit 2012 sends the rewritten IP address to the in-vehicle device 100 as a response (DNS reply) to the DNS query. In parallel with this, the address concealment unit 2012 sets the translation rules used for translation to the translation device 300. This makes it possible to have the connection request generated by the in-vehicle device 100 appropriately rewritten at the stage before forwarding it to the Internet.

The storage 202 comprises a main memory and an auxiliary memory. The main memory is the memory in which the programs executed by the controller 201 and the data used by the control programs are developed. The auxiliary storage device is a device in which programs executed in the controller 201 and data used by the control program are stored.

Communication unit 203 is a communication interface for connecting the resolver DNS 200 to the network. The communication unit 203 comprises, for example, a network interface board and wireless communication circuitry for wireless communication.

Next, the translation device 300 is described. The translation device 300 is a device that rewrites the destination IP address and source IP address in the IP header of packets sent and received by the in-vehicle device 100 based on the translation rules set by the resolver DNS 200.

Like the resolver DNS 200, the translation device 300 can be configured as a computer with a processor such as a CPU or GPU, main memory such as RAM or ROM, and auxiliary storage such as EPROM, hard disk drive, or removable media.

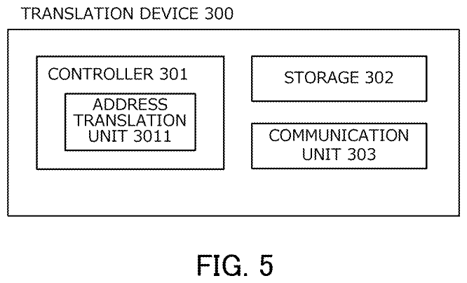

FIG. 5 shows the system configuration of the translation device 300. The translation device 300 comprises a controller 301, a storage 302, and a communication unit 303.

The controller 301 is an arithmetic unit that governs the control performed by the translation device 300. The controller 301 can be realized by an arithmetic processor such as a CPU.

The controller 301 includes an address translation unit 3011 as a functional module. The functional module may be realized by executing the program stored in the auxiliary storage by the CPU.

The address translation unit 3011 rewrites the destination IP address included in the connection request sent by the in-vehicle device 100 based on the translation rules set by the resolver DNS 200.

Specifically, when a connection request is sent from the in-vehicle device 100 with the second IP address as the destination, this is rewritten to the first IP address and forwarded to the Internet.

IP address rewriting can be achieved using the Network Address Translation (NAT) function.

When the address translation unit 3011 receives a packet sent from the server apparatus 500, it rewrites the source IP address included in the packet. Specifically, when a packet with the first IP address as the source is sent from the server apparatus 500, it is rewritten to the second IP address and forwarded to the in-vehicle device 100.

When the address translation unit 3011 performs this operation, all IP addresses of the server apparatus 500 are replaced from the first IP address to the second IP address in the vehicle-side network.

The description of storage 302 and communication unit 303 is omitted since they are the same as storage 202 and communication unit 203.

The configurations shown in FIGS. 2, 3, and 5 are examples, and all or some of the functions shown may be performed using specially designed circuits. Programs may also be stored or executed by a combination of main and auxiliary memory devices other than those shown in the figure.

Next, the communication flow when the in-vehicle device 100 connects to the server apparatus 500 will be described in more detail.

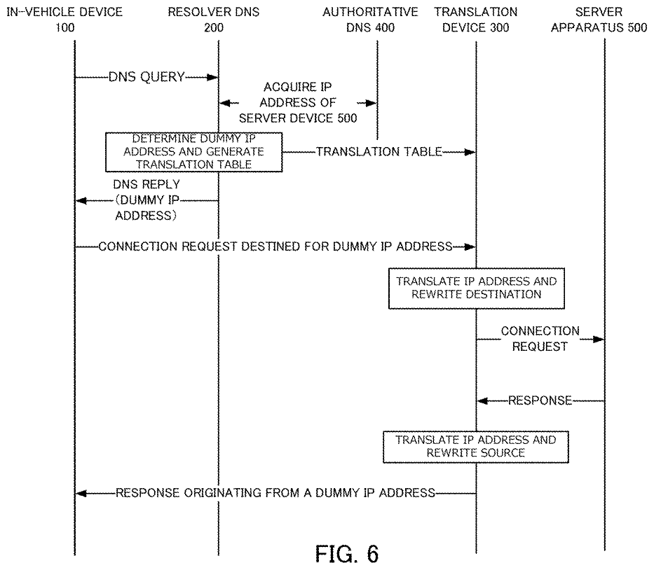

FIG. 6 is a sequence diagram showing the flow of data when the in-vehicle device 100 connects to the server apparatus 500. In the example in FIG. 6, the gateway (access point) in the vehicle-side network is omitted from the figure.

First, the in-vehicle device 100 generates a DNS query to obtain the IP address of the server apparatus 500. The DNS query is sent to the access point to which the in-vehicle device 100 is connected and forwarded to the resolver DNS 200.

Resolver DNS 200 recursively queries the upper DNS servers to obtain the IP address (first IP address) of the server apparatus 500. The IP address of the server apparatus 500 is ultimately provided by the authoritative DNS 400.

The resolver DNS 200 then generates a second IP address, which is a dummy IP address corresponding to the first IP address obtained. It also generates a translation table that associates the first IP address, the second IP address, and the IP address of the in-vehicle device 100 with each other, and sends this table to the translation device 300. This sets the translation rules generated by the resolver DNS 200 to the translation device 300.

The translation table includes the first IP address, the second IP address, and the IP address of the in-vehicle device 100 associated with each other.

The resolver DNS 200 also returns a second IP address to the in-vehicle device 100 as a response (DNS reply) to the DNS query.

If the first IP address is provided in both IPv4 and IPv6, the second IP address should also be generated in both IPv4 and IPv6. In this case, both the A record in the DNS reply and the AAAA record are subject to rewriting.

The in-vehicle device 100 generates a connection request with the second IP address as the destination and sends the connection request to the gateway (access point) in the vehicle-side network. The connection request is forwarded to the translation device 300. The destination IP address included in such connection request is a dummy.

When the translation device 300 receives a connection request that meets the following conditions, it rewrites the destination IP address according to the translation table.
(1) The IP address of the device (in-vehicle device 100) that sent the connection request matches the IP address of the target device registered in the translation table.
(2) The destination in the IP header matches the translation destination IP address registered in the translation table.

By this configuration, destination IP address in the IP header is rewritten from the second IP address to the first IP address. The connection request with the destination IP address rewritten is forwarded to the Internet and reaches the server apparatus 500.

The server apparatus 500 generates packets based on the connection request and sends them back to the translation device 300.

When the translation device 300 receives a packet that meets the following conditions, it rewrites the source IP address according to the translation table.
(1) The destination IP address matches the IP address of the target device registered in the translation table.
(2) The source IP address in the IP header matches the translation source address registered in the translation table.

By this configuration, the source IP address in the IP header is rewritten from the first IP address to the second IP address. The packet with the rewritten source IP address arrives at the in-vehicle device 100.

In the above explanation, the in-vehicle device 100 sends a connection request to the server apparatus 500, and the server apparatus 500 returns a packet in response. Similar processing is performed by the translation device 300 in communication after the connection between the in-vehicle device 100 and the server apparatus 500 is completed.

In the following description, data sent by the in-vehicle device 100 to the server apparatus 500 is referred to as a request, and the response to this request is referred to as a response.

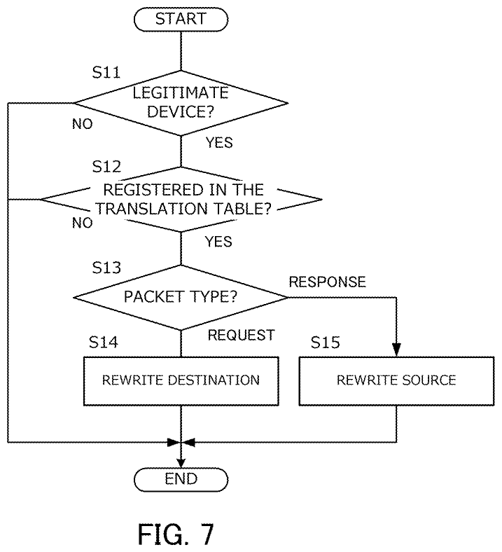

FIG. 7 is a flowchart of the process performed by the translation device 300. The illustrated process is initiated when the translation device 300 receives a request from the in-vehicle device 100 or a response to it from the server apparatus 500.

First, in step S11, it is determined whether the device that sent the request is legitimate or not. In this step, a positive decision is made if the IP address of the in-vehicle device 100 included in the request or response is present in the target device field of the translation table.

In step S12, it is determined whether the IP address to be translated is registered in the translation table. If a request is received from the in-vehicle device 100 and the destination included in the request exists in the translation table (translation destination field), this step is an affirmative decision. If a response is received from the server apparatus 500 and the transmission source in the response is present in the translation table (translation source field), this step is an affirmative decision.

In step S13, it is determined whether the packet type is a request or a response. If the packet type is a request, the process transitions to step S14, where the translation device 300 rewrites the destination in the IP header from the second IP address to the first IP address. If the packet is a response, the process transitions to step S15, where the translation device 300 rewrites the source in the IP header from the first IP address to the second IP address.

As explained above, in the communication system for the first embodiment, the resolver DNS 200 generates a dummy IP address and answers to the in-vehicle device 100 as the IP address of the server apparatus 500. In addition, the resolver DNS 200 generates a translation table containing dummy IP addresses and shares it with the translation device 300. The translation device 300 rewrites the destination and source of the packet based on the translation table.

According to such a configuration, all server apparatus 500 are replaced from the first IP address to the second IP address in the vehicle-side network. In other words, even if packets are eavesdropped within the vehicle-side network, the destination cannot be identified.

Furthermore, the translation device 300 refuses to relay packets sent from devices that are not registered in the translation table. Devices that do not access the server apparatus 500 through legitimate procedures are not registered in the translation table, preventing an attacker from attempting a replay attack against the server apparatus.

### A Variation of the First Embodiment

In the first embodiment, the example shows that the resolver DNS 200 and the translation device 300 are separate devices, but the resolver DNS 200 and the translation device 300 may be the same device. Furthermore, the resolver DNS 200, the translation device 300, and the access point may be the same device.

The translation table transmitted to the translation device 300 may be deleted when the predetermined timing arrives. For example, the translation device 300 may erase the translation table at the timing when all communications initiated by the in-vehicle device 100 are completed, or when a predetermined period of time has elapsed since the first request.

In the first embodiment, the resolver DNS 200 generated a dummy IP address (second IP address) after obtaining the IP address of the server apparatus 500, but it is not limited to this form. In other words, the second IP address may be generated at any time between the receipt of the DNS query and the return of the DNS reply.

The second IP address may be selected from a pre-generated list (e.g., by order, random, etc.), or it may be generated dynamically by any method, such as function arithmetic, random generation, etc.

In the first embodiment, the IP address of the in-vehicle device 100 was registered in the translation table. However, any identification information that can identify the in-vehicle device 100 may be registered in the translation table other than the IP address (for example, MAC address).

### Other Variants

The above embodiments are examples only, and the present disclosure may be modified and implemented as appropriate without departing from the gist thereof.

For example, the processes and units described in this disclosure may be freely combined and implemented as long as no technical contradictions arise.

Processing described as being performed by one apparatus may be shared and executed by a plurality of apparatuses. Or alternatively, processing described as being performed by different apparatuses may be executed by one apparatus. In a computer system, what hardware configuration (server configuration) each function is realized by can be flexibly changed.

The present disclosure can be realized by supplying a computer program implemented with the functions described in the above embodiments to a computer, and one or more processors that the computer has reading out and executing the program. Such a computer program may be provided for the computer by a non-transitory computer-readable storage medium connectable to a system bus of the computer or may be provided for the computer via a network. As the non-transitory computer-readable storage medium, for example, a disk of a given type such as a magnetic disk (a floppy (R) disk, a hard disk drive (HDD) and the like) and an optical disc (a CD-ROM, a DVD disc, a Blu-ray disc and the like), a read-only memory (ROM), a random-access memory (RAM), an EPROM, an EEPROM, a magnetic card, a flash memory, an optical card, and a medium of a given type that is appropriate for storing electronic commands are included.

What is claimed is:

1. An information processing apparatus comprising a controller configured to execute:
obtaining, from a user device, a query requesting name resolution of a first device accessible via a wide area network by DNS protocol;
obtaining a first IP address, which is an IP address of the first device, based on the query;
generating a second IP address that is a dummy IP address corresponding to the first IP address;
replacing the first IP address with the second IP address, and transmitting a response to the query to the user device, with the second IP address as result of the name resolution; and
when a connection request addressed to the second IP address is received from the user device, transmitting the connection request to the wide area network, after replacing a destination from the second IP address to the first IP address.

2. The information processing apparatus according to claim 1, wherein
the controller is further configured to:
when receiving a response message corresponding to the connection request from the first device, replace a transmission source included in the response message from the first IP address with the second IP address, and forward the response message to the user device.

3. The information processing apparatus according to claim 1, wherein
the controller is configured to replace the first IP address with the second IP address using different rules for each of a plurality of user devices.

4. The information processing apparatus according to claim 1, wherein
the controller is configured to associate the first IP address, the second IP address, and an identification information of the user device with each other and register them in a translation table, and perform the replacement for each of the user devices, using the translation table.

5. The information processing apparatus according to claim 4, wherein
the controller is configured to perform the replacement, when receiving the connection request addressed to the second IP address from the user device registered in the translation table.

6. The information processing apparatus according to claim 4, wherein
the controller is configured to perform the replacement, when receiving the connection request addressed to the second IP address from the user device registered in the translation table, and reject the connection, when receiving the connection request addressed to the second IP address from a device not registered in the translation table.
